(19) United States
(12) Patent Application Publication
(10) Pub. No.: US 2010/0162330 A1
(43) Pub. Date: Jun. 24, 2010

(54) METHOD, APPARATUS AND SYSTEM FOR DYNAMIC PLAYLIST OVER-RIDE

(76) Inventors: Gregory Charles Herlein, San Francisco, CA (US); Keith Ball, San Jose, CA (US)

Correspondence Address: Robert D. Shedd, Patent Operations;THOMSON Licensing LLC, P.O. Box 5312, Princeton, NJ, 08543-5312, US

(21) Appl. No.: 12/733,291

(22) PCT Filed: Dec. 19, 2007
(86) PCT No.: PCT/US07/26029

§ 371 Date: Feb. 22, 2010

Related U.S. Application Data
(60) Provisional application No. 60/965,928, filed on Aug. 23, 2007.

(51) Int. Cl. H04N 7/173

(52) U.S. Cl. 725/93

(57) ABSTRACT

Embodiments of the present provide a method, apparatus and system for the control and override of the playout of playlists. That is, the various embodiments of the present invention provide a means of effecting changes to a playlist and remove the need to provide a totally new playlist. In one embodiment of the present invention, a media playback system dynamically applies change instructions in real-time to existing playlists rather than building new playlists. More specifically, in one embodiment of the present invention a method for providing a dynamic override of at least a portion of a playlist includes identifying a location in the playlist that requires change and changing a media portion presented during the intended presentation time of the identified location in the playlist without modifying the playlist.

### CROSS REFERENCE TO RELATED APPLICATIONS

This application claims the benefit of U.S. provisional patent application No. 60/965,928, filed Aug. 23, 2007, which is herein incorporated by reference in its entirety.

### FIELD OF THE INVENTION

The present invention generally relates to playlist-based audio/video systems and, more particularly, to a method, apparatus and system for the control and over-ride of playlists.

### BACKGROUND OF THE INVENTION

Information and content distribution systems are used to provide information and content to a plurality of end systems. For example, in video-on-demand applications media content has been made available to and utilized by satellite/cable television subscribers. Typically, subscribers can view at their television via a set-top box the video programs available for selection (sometimes for an additional fee) and upon selection made at the subscriber's set-top-box (STB), the program is sent from the program center to the set-top-box via the cable or satellite network. Playlists can be implemented in video-on-demand applications to schedule video programming and advertisements.

Similarly, in the advertising realm, providing in-store retail media content is becoming the most popular advertising medium in use today, with broadcast distribution being its primary means of content presentation. That is, in recent years retailers and the managers of public spaces have brought in video display systems for advertising use. In such systems, content is distributed by a server and received at a respective set-top-box for each display or group of displays. Retailers use the displays to present their current offerings or sale information, while the public spaces sell time on the video displays to advertisers either national or local, knowing that large numbers of consumers will see the presentation. Again, in such in-store retail advertising systems, playlists can be implemented to schedule media clips of current offerings, sale information or advertisements.

In such systems, many situations can arise that require dynamic changes to the playlist to meet business objectives—such as substituting a specific media file or set of media files for others; not playing a specific media file or set of media files; inserting a specific media file or set of media files. Building a new playlist at a centralized network operations center may not be a viable solution in these cases. Possible reasons can include the desire for the changes to happen as rapidly as possible (thus bypassing the time required to process through the central system) or the desire to allow a local entity to have control over the playlists without having to coordinate with the central system.

### SUMMARY OF THE INVENTION

Embodiments of the present invention address the deficiencies of the prior art by providing a method, apparatus and system for the control and override of the playout of playlists.

The various embodiments of the present invention include a means of providing only the changes to be made to a playlist and remove the need to provide a totally new playlist. In one embodiment of the present invention, a media playback system would dynamically apply change instructions in real-time to existing playlists rather than building new playlists.

In one embodiment of the present invention a method for providing a dynamic override of at least a portion of a playlist includes identifying a location in the playlist that requires change and changing a media portion presented during the intended presentation time of the identified location in the playlist without modifying the playlist.

In an alternate embodiment of the present invention, a playout system for providing a dynamic override of at least a portion of a playlist includes at least one programming control system for providing at least playlist override instructions and at least one playout apparatus for executing the playlist override instructions where the playout apparatus is adapted to perform the steps of identifying a location in the playlist that requires change and changing a media portion presented during the intended presentation time of the identified location in the playlist without modifying the playlist.

### BRIEF DESCRIPTION OF THE DRAWINGS

The teachings of the present invention can be readily understood by considering the following detailed description in conjunction with the accompanying drawings, in which:

FIG. 1 depicts a high level block diagram of a content distribution system in which an embodiment of the present invention can be applied;

FIG. 2 depicts a high level block diagram of an in-store advertising network for providing in-store advertising;

FIG. 3 depicts a flow diagram of a method for a playlist override or update in accordance with an embodiment of the present invention;

FIG. 4 depicts a functional high level block diagram of a system for providing a playlist override or update in accordance with on embodiment of the present invention; and

FIG. 5 depicts a high level block diagram of an embodiment of a playout apparatus suitable for use in the playout system 400 of FIG. 4 in accordance with an embodiment of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

The present invention advantageously provides a method, apparatus and system for the control and over-ride of local playlists for causing changes to the presentation of an existing playlist. Although the present invention will be described primarily within the context of a retail advertising network environment, the specific embodiments of the present invention should not be treated as limiting the scope of the invention. It will be appreciated by those skilled in the art and informed by the teachings of the present invention that the concepts of the present invention can be advantageously applied in substantially any content distribution environment.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

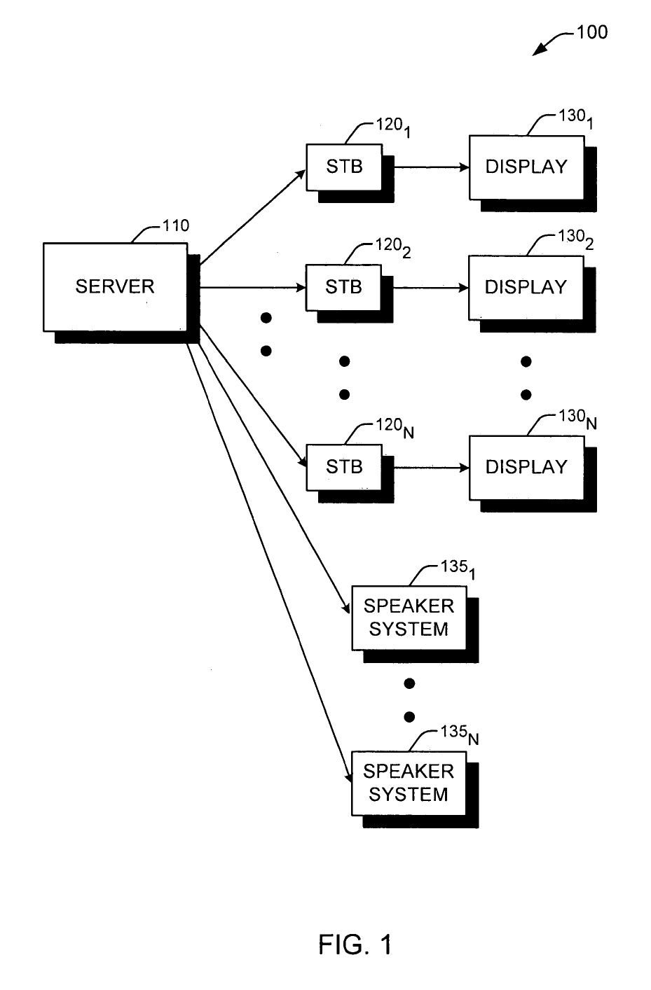

FIG. 1 depicts a high level block diagram of a content distribution system in which an embodiment of the present invention can be applied. The content distribution system 100 of FIG. 1 illustratively comprises at least one server 110, a plurality of receiving devices such as tuning/decoding means (illustratively set-top boxes (STBs)) 120₁-120ₙ, and a respective display 130₁-130ₙ for each of the set-top boxes 120₁-120ₙ, and other receiving devices, such as audio output devices (illustratively speaker systems) 135₁-135ₙ. Although in the system 100 of FIG. 1, each of the plurality of set-top boxes 120₁-120ₙ, is illustratively connected to a single, respective display, in alternate embodiments of the present invention, each of the plurality of set-top boxes 120₁-120ₙ, can be connected to more than a single display. In addition, although in the content distribution system 100 of FIG. 1 the tuning/decoding means are illustratively depicted as set-top boxes 120, in alternate embodiments of the present invention, the tuning/decoding means of the present invention can comprise alternate tuning/decoding means such as a tuning/decoding circuit integrated into the displays 130 or other stand alone tuning/decoding devices and the like. Even further, receiving devices of the present invention can include any devices capable of receiving content such as audio, video and/or audio/video content.

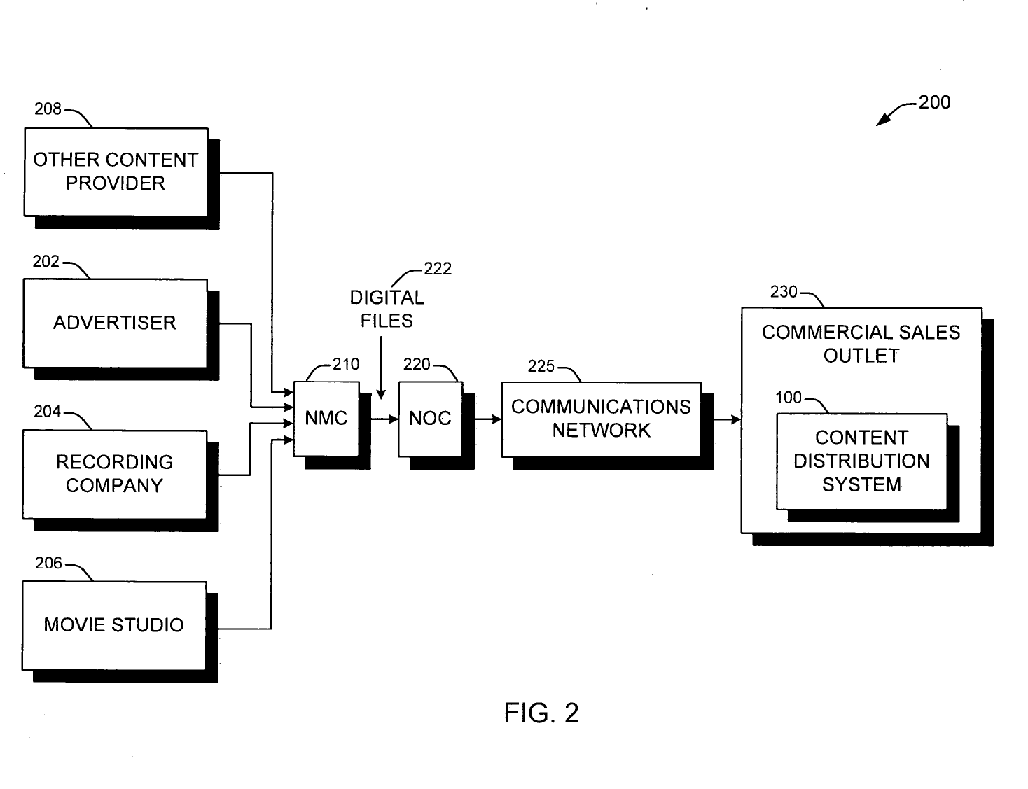

In one embodiment of the present invention, the content distribution system 100 of FIG. 1 can be a part of an in-store advertising network. For example, FIG. 2 depicts a high level block diagram of an in-store advertising network 200 for providing in-store advertising. In the advertising network 200 of FIG. 2, the advertising network 200 and distribution system 100 employ a combination of software and hardware that provides cataloging, distribution, presentation, and usage tracking of music recordings, home video, product demonstrations, advertising content, and other such content, along with entertainment content, news, and similar consumer informational content in an in-store setting. The content can include content presented in compressed or uncompressed video and audio stream format (e.g., MPEG4/MPEG4 Part 10/AVC-H.264, VC-1, Windows Media, etc.), although the present system should not be limited to using only those formats.

In one embodiment of the present invention, software for controlling the various elements of the in-store advertising network 200 and the content distribution system 100 can include a 32-bit operating system using a windowing environment (e.g., MS-Windows™ or X-Windows operating system) and high-performance computing hardware. The advertising network 200 can utilize a distributed architecture and provides centralized content management and distribution control via, in one embodiment, satellite (or other method, e.g., a wide-area network (WAN), the Internet, a series of microwave links, or a similar mechanism) and in-store modules.

As depicted in FIG. 2, the content for the in-store advertising network 200 and the content distribution system 100 can be provided from an advertiser 202, a recording company 204, a movie studio 206 or other content providers 208. An advertiser 202 can be a product manufacturer, a service provider, an advertising company representing a manufacturer or service provider, or other entity. Advertising content from the advertiser 202 can consist of audiovisual content including commercials, “info-mercials”, product information and product demonstrations, and the like.

A recording company 204 can be a record label, music publisher, licensing/publishing entity (e.g., BMI or ASCAP), individual artist, or other such source of music-related content. The recording company 204 provides audiovisual content such as music clips (short segments of recorded music), music video clips, and the like. The movie studio 206 can be a movie studio, a film production company, a publicist, or other source related to the film industry. The movie studio 106 can provide movie clips, pre-recorded interviews with actors and actresses, movie reviews, “behind-the-scenes” presentations, and similar content.

The other content provider 208 can be any other provider of video, audio or audiovisual content that can be distributed and displayed via, for example, the content distribution system 100 of FIG. 1.

In one embodiment of the present invention, content is procured via the network management center 210 (NMC) using, for example, traditional recorded media (tapes, CD's, videos, and the like). Content provided to the NMC 210 is compiled into a form suitable for distribution to, for example, the local distribution system 100, which distributes and displays the content at a local site.

The NMC 210 can digitize the received content and provide it to a Network Operations Center (NOC) 220 in the form of digitized data files 222. It will be noted that data files 222, although referred to in terms of digitized content, can also be streaming audio, streaming video, or other such information. The content compiled and received by the NMC 210 can include commercials, bumpers, graphics, audio and the like. All files are preferably named so that they are uniquely identifiable. More specifically, the NMC 210 creates distribution packs that are targeted to specific sites, such as store locations, and delivered to one or more stores on a scheduled or on-demand basis. The distribution packs, if used, contain content that is intended to either replace or enhance existing content already present on-site (unless the site's system is being initialized for the first time, in which case the packages delivered will form the basis of the site's initial content). Alternatively, the files may be compressed and transferred separately, or a streaming compression program of some type employed.

The NOC 220 communicates digitized data files 222 to, in this example, the content distribution system 100 at a commercial sales outlet 230 via a communications network 225. The communications network 225 can be implemented in any one of several technologies. For example, in one embodiment of the present invention, a satellite link can be used to distribute digitized data files 222 to the content distribution system 100 of the commercial sales outlet 230. This enables content to easily be distributed by broadcasting (or multicasting) the content to various locations. Alternatively, the Internet can be used to both distribute audiovisual content to and allow feedback from commercial sales outlet 230. Other ways of implementing communications network 225, such as using leased lines, a microwave network, or other such mechanisms can also be used in accordance with alternate embodiments of the present invention.

The server 110 of the content distribution system 100 is capable of receiving content (e.g., distribution packs) and, accordingly, distribute them in-store to the various receivers such as the set-top boxes 120 and displays 130 and the speaker systems 135. That is, at the content distribution system 100, content is received and configured for streaming. The streaming can be performed by one or more servers configured to act together or in concert. The streaming content can include content configured for various different locations or products throughout the sales outlet 230 (e.g., store). For example, respective set-top boxes 120 and displays 130 and various speaker systems 135 can be located at specific locations throughout the sales outlet 230 and respectively configured to display content and broadcast audio pertaining to products located within a predetermined distance from the location of each respective set-top box and display.

The server 110 of the content distribution system 100 receives content and creates various different streams (e.g., content channels) of audio, video and/or audio/video to be communicated to the various receivers throughout the store. The streams can be individual channels of modulated audio, video and/or audio/video onto a radio frequency distribution or transmitted as data flows within a unicast or multicast internet protocol (IP) network. These streams can originate from one or more servers under the same logical set of control software.

The various embodiments of the present invention provide a means to codify a set of changes to a playlist or a set of playlists. These changes can be applied according to instructions with defined conditions included in playlist override information provided to a playout system/apparatus. In one embodiment of the present invention, the playout system/apparatus can comprise the server 110 of the content distribution system 100. In alternate embodiments of the present invention, however, the playout system/apparatus can comprise a separate unit or device, which will be described in more detail below.

These defined conditions can include applying the changes for specific periods of time (or patterns of time, such as every day from 2 pm to 4 pm), specific playout locations (such as specific stores or channels), or specific presentation locations (such as display or speaker locations). For example, some advertising media can be determined to be more suitable for certain times of the day, for example because of adult content in advertising material, or can be determined to be more suitable for certain locations, for example because of demographics (e.g., content in different languages or directed to different age groups), or can be determined to be more suitable for locations in a store because of product in the proximity of the display or speaker locations. As such, in accordance with the various embodiments of the present invention, media portions can be inserted, deleted, overridden and/or replaced (described below) to accommodate for such factors without having to modify existing playlists.

The playlist override information of the present invention can include conditional rules where the override instructions would not be processed unless other conditions associated with the media, the playout system or the location of the playout system were met, such as digital rights management processing, service level agreement with an advertiser or media provider, playout system status, impressions, and product movement related to the media including sales transactions and inventory to name a few.

In various embodiments of the present invention, the playlist override information can include instructions that can be of three basic types: insert, replace, and delete. Inserts would add a new clip or playlist at a specified point in the playlist being over-ridden. Note that the playlist would not change, only the interpretation of the playlist by the playout system/apparatus at run-time would change. Likewise, delete instructions would result in the specified clip or clips not playing in the realized run-time playback. Replace operations would result in a different specific media clips being played in place of specific other clips in the playlist.

In one embodiment of the present invention, the playlist override information and instructions can be generated in response to conditions associated with the programming or media change after the playlist or playlists have been created and distributed. These conditions can include problems or concerns with the media referenced in the existing playlist at a playout system, problems fulfilling the advertiser's or media provider's service agreement, an advertiser's or other media provider's campaign changes associated with changes in consumer behavior, impressions, product or service availability, the venue owner where the playout system is located, such as a retailer or building owner, has promotional or communication needs that change, or the consumer makes requests of the system to add or remove content based on their needs. In accordance with various embodiments of the present invention, the changes can be made from a central programming control system, for example at the network management center 210 or the network operations center 220, or several programming control systems (e.g., interfaces) driven by, for example, local users, a network operator, an advertiser, a media provider, a venue owner (such as retailer), and a consumer with access to the playout system. The venue owner can empower central personnel or local personnel to make the changes based on local needs versus the needs of multiple playout system locations or a centralized network.

In one embodiment of the present invention, a playout system receives override information for a specific and identified playlist from at least one of a network management center, a network operations center or from a local server in, for example, a retail advertising environment. The override information can include identification information identifying a specific one or specific ones of playlist(s) that require a change. The override information can further include media clips or portions intended to replace specific media portions in the playlist to be changed or can include media portions to be added to a playlist. The override information can further include information as to a portion or portions of an identified playlist or playlists to be deleted and as such not presented by a receiver (e.g., display or speaker).

In one embodiment of the present invention, in order to track and understand changes occurring for the proper recognition of playout results, the playout system can generate a new playlist with the override instructions executed showing the changes that will be taken under the current conditions occur. The conditions would be recorded in the new playlist as well as the changes to the media, sequencing and layout. This new playlist can be returned to the programming control system, which could then use it as the definition of expected execution at the playout site. When the playout system records and transmits back to the programming control system the actual executed results, it will be able to correlate the expected with the actual based on the new playlist as well as integrate with the conditions that caused the playlist changes or additional conditions, such as consumer behavior changes or lack of changes, product or service availability, impressions, and create either new playlists or new playlist override instructions. In addition, the expected and actual playout status could be used to establish a proof of performance to the advertiser, media provider, or venue owner.

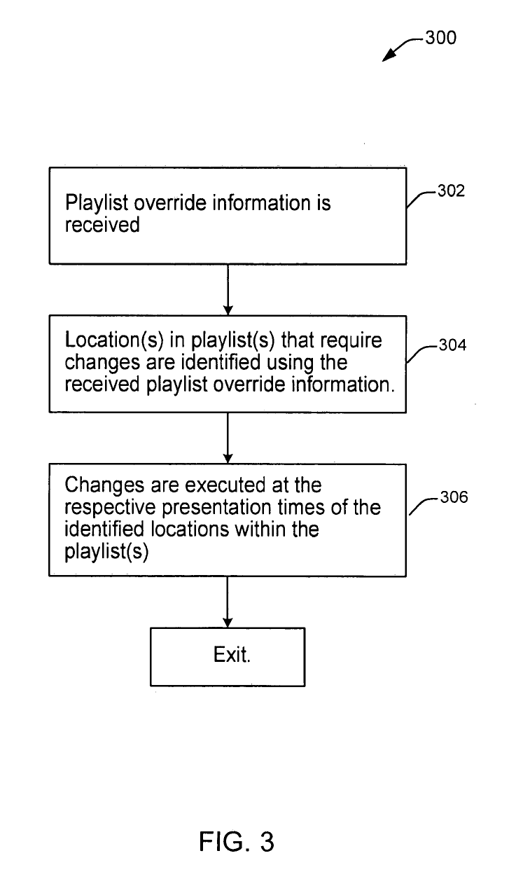

FIG. 3 depicts a flow diagram of a method for a playlist override or update in accordance with an embodiment of the present invention. The method 300 of FIG. 3 begins at step 302 during which playlist override information is received. The method 300 then proceeds to step 304.

At step 304, a location or locations in a playlist or playlists that require changes are identified using the received playlist override information. The method 300 then proceeds to step 306.

At step 306, the changes are executed at the respective presentation (i.e., display for video and presentation for audio) times of the identified locations within the playlist(s). More specifically, at step 306, if an identified portion of a playlist requires changes (e.g., replacment, insertion, deletion, of a media portion), a playout apparatus/system executes the changes identified in the playlist override information by causing the presentation at a receiver of an alternate media portion in place of an identified media portion of the playlist requiring replacement, and/or by causing an identified media portion of the playlist requiring deletion not to be performed and/or by causing the performance of a media portion identified as needing to be added to the playlist at the point in time of an identified location in the playlist. The method 300 is then exited.

In accordance with the embodiments of the invention described above, the playlist override playout is performed without having to make any modifications to the playlist, itself. Instead, a playout system/apparatus, in response to a received request for modification of a playlist and in accordance with received playlist override information, causes changes in a playout of a playlist at an end receiver (e.g., a display or a speaker) by either causing the playout of alternate video and/or audio content over identified media content of the playlist at an end receiver, or by causing a portion of the media content in the playlist identified by the playlist override information to be deleted not to be played out by the end receivers, or by adding media content to a playlist by causing end receivers to receive the additional media content during an identified time. In one embodiment of the present invention, the addition content and replacement content is provided to a playout system/apparatus along with the playlist override information. In alternate embodiments of the present invention, a playout system/apparatus of the present invention can have storage means (such as a memory, or hard disk, etc.) for storing media content to be used for the playlist override concepts of the present invention.

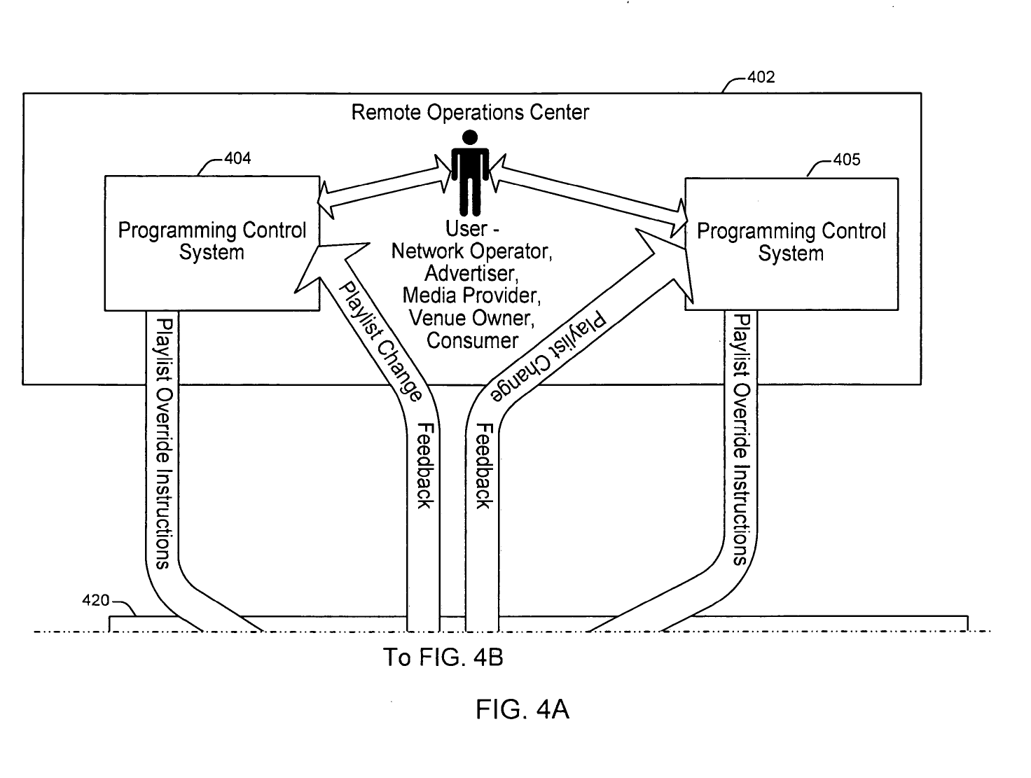

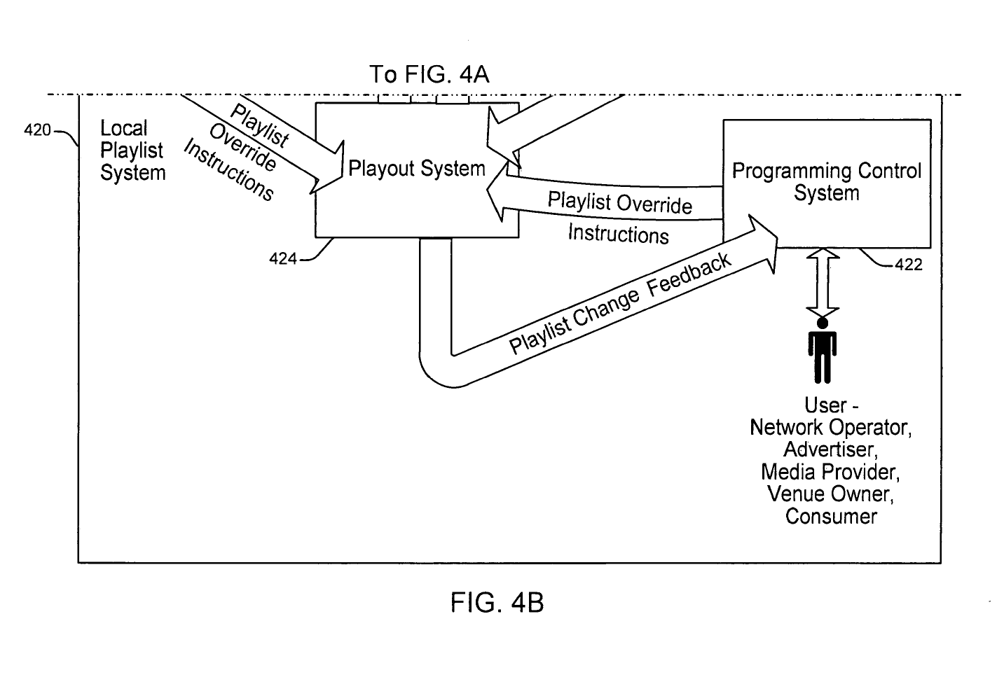

FIG. 4 depicts a functional high level block diagram of a system for providing a playlist override or update in accordance with on embodiment of the present invention. The system 400 of FIG. 4 illustratively comprises a remote operations center 402 including two remote programming control systems 404, 405. In one embodiment of the present invention, the two remote programming control systems 404, 405 can comprise control devices of, for example, the network management center 210 and the network operations center 220 including user interfaces. As depicted in the embodiment of FIG. 4, users of the remote programming control systems can include at least one of a network operator, an advertiser, a media provider, a venue owner and a consumer.

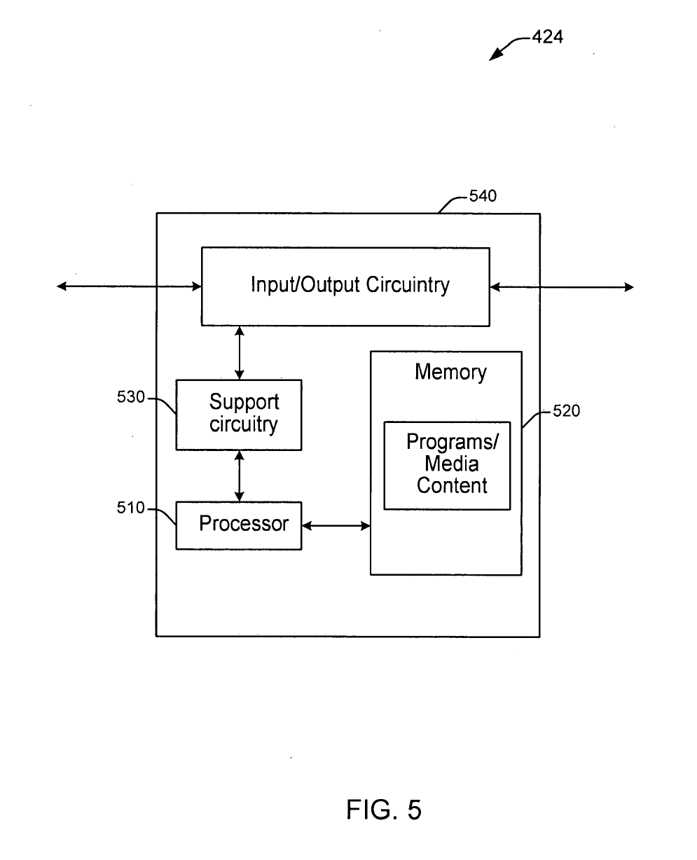

The system of FIG. 4 also illustratively comprises a local playout system 420 including a local programming control system 422 and a local playout apparatus 424. As previously described, in one embodiment of the present invention, the local playout apparatus 424 can comprise the server 110 of the content distribution system 100. In alternate embodiments of the present invention, however, the playout system/apparatus can comprise a separate unit or device. For example, FIG. 5 depicts a high level block diagram of an embodiment of a playout apparatus suitable for use in the playout system 400 of FIG. 4 in accordance with an embodiment of the present invention.

The playout apparatus 424 of FIG. 5 illustratively comprises a processor 510 as well as a memory 520 for storing control programs (e.g., playlist processor software, streaming server software), stored media content and the like. The processor 510 cooperates with conventional support circuitry 530 such as power supplies, clock circuits, cache memory and the like as well as circuits that assist in executing the software routines stored in the memory 520. As such, it is contemplated that some of the process steps discussed herein as software processes may be implemented within hardware, for example, as circuitry that cooperates with the processor 510 to perform various steps. The processor 510 of the playout apparatus can comprise a CPU including, but not limited to, an audio and video processor (not shown). The playout apparatus 424 also contains input-output circuitry 540 that forms an interface between the various functional elements communicating with the playout apparatus 424.

Although the playout apparatus 424 of FIG. 5 is depicted as a general purpose computer that is programmed to perform various control functions in accordance with the present invention, the invention can be implemented in hardware, for example, as an application specified integrated circuit (ASIC). As such, the process steps described herein are intended to be broadly interpreted as being equivalently performed by software, hardware, or a combination thereof.

Referring back to FIG. 4, in the system 400 playlist override information can be communicated to the playout apparatus 424 from the remote operations center 402 from either of the two remote programming control systems 404, 405, in one embodiment, along with media content. In addition, the playlist override information in accordance with the present invention can be communicated to the playout apparatus 424 from the local programming control system 422 of the local playout system, in one embodiment, along with media content. Although in the embodiment of FIG. 4, the playlist override information is described as being communicated along with media content, in alternate embodiments of the invention, playlist override information can be sent separately and at different times than the communicated media content.

Upon receiving the playlist override information and the media content, the playout apparatus 424 identifies areas in the media content that require changes or updates by using the playlist override information. The playout apparatus 424 then executes the required changes before communicating the media content to a end receiver (e.g., display or speaker) for display or presentation. More specifically, the playlist override information received by the playout apparatus 424 can identify specific portions of the media content that require deletion, or that need to be overwritten or areas in the media content that require additional media added. The playout apparatus 424 then causes the presentation of the corrected or updated media content by, in the case of replacement media connate and additional media content, causing the alternate or additional data to be communicated to a respective end receiver for presentation in place of the original media content. For the case of the deletion of media content, the playout apparatus 424 causes the media content to be deleted to not be communicated to a respective end receiver.

As depicted in FIG. 4, the playout apparatus 424 can further provide playlist change feedback to the programming control systems 404, 405 and 422. That is and as previously described, in order to track and understand changes occurring for the proper recognition of playout results, the playout apparatus 424 can generate a new playlist with the override instructions executed showing the changes that will be taken under the current conditions. The conditions would be recorded in the new playlist as well as the changes to the media, sequencing and layout. This new playlist can be returned to the programming control systems 404, 405 and 422, which could then use it as the definition of expected execution at a playout site (not shown). When the playout apparatus 424 records and transmits back to the programming control system the actual executed results, the expected results can be correlated with the actual based on the new playlist.

As previously described, in one embodiment of the present invention, additional or alternate media content for fulfilling the requirements of the playlist override information can be communicated to the playout apparatus 424, for example along with the media content or the playlist override information or at a separate time. In alternate embodiments of the present invention, additional or alternate media content for fulfilling the requirements of the playlist override information can be stored in a memory or storage means of the playout apparatus 424.

It should be noted that the use of the term “display” throughout the teachings of this disclosure should not be considered as being limited to the presentation of video, but can be representative of either the presentation of video on, for example, a display or the presentation of audio on, for example, a speaker and/or both on an integrated device. In addition, it should be noted that the term “media content” and/or “media portion” and/or “media clip” used throughout the teachings of this disclosure can be used to identify media content including video portions, audio portions and/or both.

Having described various embodiments for a method, apparatus and system for the control and over-ride of the presentation of playlists (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention. While the forgoing is directed to various embodiments of the present invention, other and further embodiments of the invention may be devised without departing from the basic scope thereof.

1. A method for providing a dynamic override of at least a portion of a playlist, comprising:
identifying a location in the playlist that requires change; and
changing a media portion presented during the intended presentation time of the identified location in the playlist without modifying the playlist.

2. The method of claim 1, wherein said playlist comprises a compilation of retail advertising media portions to be presented in a retail advertising environment.

3. The method of claim 1, wherein presenting a media portion comprises at least one of displaying video content on a display and playing audio content on a speaker.

4. The method of claim 1, wherein said change comprises a replacement of a media portion of the playlist intended to be presented during a presentation time of the identified location with an alternate media portion and a playout system causes the presentation of the alternate media portion during the time when the media portion of the playlist was to be presented.

5. The method of claim 1, wherein said change comprises a deletion of a media portion of the playlist intended to be presented during a presentation time of the identified location in the playlist and a playout system causes the media portion of the playlist not to be presented.

6. The method of claim 1, wherein said change comprises an addition of a media portion to the playlist and a playout system causes said additional media portion to be presented at a presentation time of the identified location in the playlist.

7. The method of claim 1, wherein said change is triggered by at least one predetermined condition.

8. The method of claim 7, wherein said at least one predetermined condition comprises at least one of a specific period of time, a specific playout location and a specific presentation location.

9. The method of claim 1, further comprising, receiving a request for said change in the playlist and receiving playlist override information from at least one of a remote distribution network and a local playout network.

10. The method of claim 1, further comprising in response to an execution of said change, generating information regarding an updated playlist including said change for verifying that said change was executed.

11. The method of claim 1, where said change is not executed unless at least one predetermined condition is satisfied.

12. The method of claim 11, wherein said at least one predetermined condition comprises at least one of a condition associated with the media, the playout system and the location of the playout system, such as digital rights management processing, service level agreement with an advertiser or media provider, playout system status, impressions, and product movement related to the media including sales transactions and inventory.

13. A playout apparatus for providing a dynamic override of at least a portion of a playlist, comprising:
a means for storing at least playlist override instructions and program instructions; and
a processor for executing said program instructions, wherein in response to said processor executing said program instructions, said playout apparatus adapted to perform the steps of:
identifying a location in the playlist that requires change; and
changing a media portion presented during the intended presentation time of the identified location in the playlist without modifying the playlist.

14. The playout apparatus of claim 13, wherein said playout apparatus causes an alternate media portion to be displayed during a time of the identified location in accordance with the playlist override instructions.

15. The playout apparatus of claim 13, wherein said playout apparatus causes a media portion of the playlist intended to be displayed during a time of the identified location not to be displayed in accordance with the playlist override instructions.

16. The playout apparatus of claim 13, wherein said playout apparatus adds a media portion to the playlist to be displayed during a time of the identified location in accordance with the playlist override instructions.

17. The playout apparatus of claim 13, wherein said playout apparatus communicates playlist change feedback information to a source of the playlist override instructions.

18. The playout apparatus of claim 17, wherein said playlist change feedback information comprises information regarding an updated playlist including playlist changes for verifying that said changes were executed.

19. The playout apparatus of claim 13, wherein said playout apparatus stores alternate media content and additional media content for fulfilling the requirements of the playlist override instructions in said means for storing.

20. A playout system for providing a dynamic override of at least a portion of a playlist, comprising:
at least one programming control system for providing at least playlist override instructions; and
at least one playout apparatus for executing said playlist override instructions, said playout apparatus adapted to perform the steps of:
identifying a location in the playlist that requires change; and
changing a media portion presented during the intended presentation time of the identified location in the playlist without modifying the playlist.

21. The playout system of claim 20, wherein said programming control system further provides media content and said playlist.

22. The playout system of claim 20, wherein said programming control system comprises a user interface.

23. The playout system of claim 22, wherein said user interface is used for inputting playlist override instructions.

24. The playout system of claim 20, wherein said at least one programming control system comprises at least one of a local programming control system and a remote programming control system.

25. A method for providing a dynamic override of at least a portion of a compiled playlist, comprising:
identifying a location in the compiled playlist that requires change; and
executing said change at the identified location of the compiled playlist without modifying the compiled playlist.
